(19) United States
(12) Patent Application Publication
(10) Pub. No.: US 2004/0146010 A1
(43) Pub. Date: Jul. 29, 2004

(54) Data processing method and device for setting up transmission channels between terminals of a communication network

(75) Inventors: Raymond Gass, Bolsenheim (FR); Michel Le Creff, Vigny (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/682,866

(22) Filed: Oct. 14, 2003

(30) Foreign Application Priority Data
Oct. 15, 2002 (FR) 02 12 823

(51) Int. Cl. H04L 12/26; H04L 12/56

(52) U.S. Cl. 370/252; 370/400

(57) ABSTRACT

A device (D) is dedicated to processing data for setting up data transmission channels between sender terminals (T1) and receiver terminals (T3) connected to a communication network by first connection means (CM1) and second connection means (CM3). The device comprises manager means (MG) connected to said communication network and adapted to receive a request for transmission of data between a sender terminal (T1) and a receiver terminal (T3), to determine information data representative of at least one of the send/receive characteristics of the second connection means (CM3) of said receiver terminal (T3) and/or information data representative of at least one of the send/receive characteristics of the first connection means (CM1) of said sender terminal (T1), for negotiating and setting up a data transmission channel between said sender and receiver terminals suited to their respective capacities and to the characteristics of their first and second connection means.

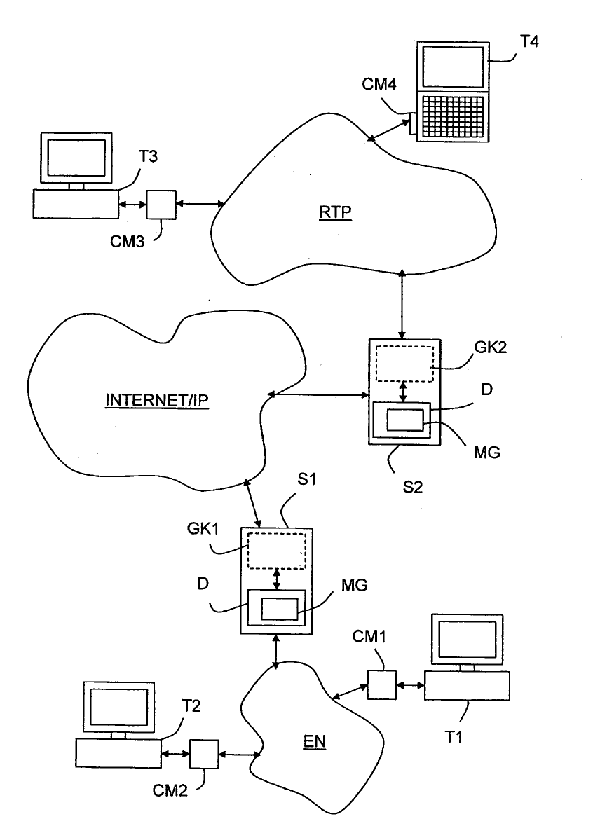

The invention relates to exchanging data between terminals within communication networks and more particularly to setting up data transmission channels between terminals.

Exchanging data between a “sender” terminal and a “receiver” terminal via a communication network necessitates, firstly, that each of said terminals be connected to the network by a connection device (or “network connection” as it is otherwise known) and, secondly, that a data transmission channel be set up between said terminals. In many networks, and in particular in the Internet and in Internet Protocol (IP) networks, the procedures for negotiating and setting up transmission channels are managed by “gatekeepers” with which the terminals are registered.

In the present context, “registered” means that the gatekeeper knows the transmission capacities and characteristics of the terminals whose transmission channels it manages.

At present, when a gatekeeper receives from a sender terminal registered with it a request for transfer of data to a receiver terminal its sets up a connection, generally via a logical signaling channel belonging to the control plan (or “plan C” as it is otherwise known), with the gatekeeper with which the receiver terminal is registered. This connection enables gatekeepers to exchange information data representative of the transmission (sending and receiving) capacities and characteristics of the sender and receiver terminals, and therefore to determine the characteristics of the transmission channel best suited to the type of data to be transmitted, given said capacities and characteristics of said terminals.

These information data exchange procedures are generally standardized.

For example, Multimedia over IP (MoIP) data exchange is defined in particular by the H.323 family of ITU standards or the Session Initialization Protocol (SIP), which is a protocol for controlling application layers and is used to create, modify and close a session having one or more participants.

When the sender and receiver terminals are coupled to the network via network connections that have a high capacity, in particular in terms of bandwidth, the standardized exchange procedures are entirely satisfactory. However, it frequently happens that the transmission capacities of the network connection of a receiver terminal and/or the network connection of a sender terminal are not sufficient for exchanging data on the transmission channel negotiated and set up by their gatekeepers, given the capacities and characteristics of said terminals. This is caused in particular by the great disparity of the hardware that constitutes the network connections, and by their bandwidths, which are from 50 kbit/s in the case of an analog modem to 50 to 100 Mbit/s in the case of a switched Ethernet connection. By way of example, a modem cannot support data exchange conforming to the H.262 standard when the bit rate is 6 Mbit/s.

Consequently, there are many situations in which the exchange of data, although it has been negotiated, cannot proceed correctly, if at all.

An object of the invention is therefore to remedy this drawback.

To this end the invention proposes a method of processing data, for setting up data transmission channels between sender terminals and receiver terminals adapted to the network connections (or first and second connection means, for example modems or WLAN or Bluetooth connections) by which they are connected to a communication network.

The method is characterized in that it consists, in the event of a request to set up a data transmission channel between a sender terminal and a receiver terminal, in determining information data representative of at least one of the send/receive characteristics of the second connection means of the receiver terminal and/or information data representative of at least one of the send/receive characteristics of the first connection means of the sender terminal, in order to negotiate and set up a data transmission channel between the sender and receiver terminals suited to their respective capacities and to the characteristics of their first and second connection means (or network connections as they are otherwise known).

At least some of the information data is preferably representative of the bandwidth of the second connection means of the receiver terminal. Likewise, at least some of the information data is preferably representative of the bandwidth of the first connection means of the sender terminal.

Moreover, information data representative of send/receive characteristics of the first connection means can be communicated at substantially the same time as the data transmission channel set-up request, i.e. before determining the information data of the second connection means. On the other hand, if information data representative of send/receive characteristics of the second connection means has been determined first, information data representative of characteristics of the first connection means can be determined afterwards.

According to another feature of the invention, the method can include an additional step in which the transmission channel between the sender terminals and receiver terminals is negotiated and set up within the network after the determination of information data.

The invention also provides a data processor device for setting up data transmission channels between sender terminals and receiver terminals connected to a communication network by first connection means and second connection means.

The processor device is characterized in that it comprises manager means connected to the communication network and adapted to receive a request for transmission of data between a sender terminal and a receiver terminal, to determine information data representative of at least one of the send/receive characteristics of the second connection means of the receiver terminal and/or information data representative of at least one of the send/receive characteristics of the first connection means of the sender terminal, for negotiating and setting up a data transmission channel between the sender and receiver terminals suited to their respective capacities and to the characteristics of their first and second connection means.

The manager means are preferably adapted to determine information data representative of the bandwidth of the second connection means. Likewise, the manager means are preferably adapted to determine information data representative of the bandwidth of the first connection means.

Also, the manager means can be adapted to receive information data representative of send/receive characteristics of the first connection means of the sender terminal at substantially the same time as the data transmission channel set-up request. Alternatively, the manager means can be adapted to determine information data (representative of send/receive characteristics for the first connection means of the sender terminal) after determination of the information data for the second connection means.

Furthermore, the manager means are preferably adapted to communicate the information data to at least one manager device (for example a gatekeeper).

According to a further feature of the invention, the manager means are adapted to determine the information data via at least one logical signaling channel.

For example, a processor device of the above kind can be integrated into a communication network manager device, such as gatekeeper, which may itself be installed in a messaging or electronic mail server or in a server having the firewall or proxy function.

The invention can be implemented in public communication networks of the PSTN, PLMN (and in particular GSM, GPRS, UMTS and i-Mode) and Internet Protocol (IP) type, as well as in private networks such as PABX and private communication gateways (or “residential gateways” as they are otherwise known) capable of used fixed wireless access technologies, such as WLAN and Bluetooth.

Moreover, the invention is particularly well suited to exchanging multimedia data in the communication networks previously cited and in particular in IP networks.

Furthermore, the invention applies to any type of network connection (or first and second connection means) and in particular to analog, ADSL, 2B+D, 30B+D, radio, Ethernet, WLAN and Bluetooth connections.

Other features and advantages of the invention will become apparent on reading the following detailed description and examining the single FIGURE of the appended drawing, which shows diagrammatically one example of a communication installation equipped with processor devices according to the invention. This FIGURE can constitute part of the description of the invention as well as, if necessary, contributing to the definition of the invention.

The invention is intended to be used for setting up data transmission channels suited to network connections by which terminals are connected to a communication network.

In the example shown in the single FIGURE, a communication network includes a private network EN, for example one belonging to a group of businesses and connected to an Internet/IP public data network by an IP router S1 that preferably has the proxy or firewall function.

The private network EN is a Private Automatic Branch Exchange (PABX), for example, possibly of the wireless kind (if it conforms to the DECT standard). However, it could equally be a Wireless Local Access Network (WLAN).

User terminals Ti (in this example i=1 and 2) are connected to the private network EN by connection means CMi, or a network connection as such means are otherwise known, preferably one having a high bit rate, for example a switched Ethernet connection. However, any other type of network connection can be envisaged, and in particular analog, ADSL, 2B+D, 30B+D, radio, WLAN and Bluetooth connections.

Moreover, as shown in the single FIGURE, the installation includes other user terminals, for example computers T3 belonging to private individuals or small companies, that are connected via a network connection CM3 to a public telephone network RTP, for example a public land mobile network (PLMN), such as a GSM, GPRS, UMTS or i-Mode network. However, it could instead be a switched network (for example a public switched telephone network (PSTN)).

The telephone network RTP is connected to the Internet/IP network by an access server S2.

For example, the network connection CM3 of a terminal T3 is an analog modem having a bandwidth of approximately 50 kbit/s or an ADSL modem. However, the other user terminals T3 could of course be mobile terminals and/or the network connections could be of the 2B+D, 30B+D, radio, Ethernet, WLAN or Bluetooth type.

Of course, the invention is not limited to this example of the combination of a private network (EN), the public switched telephone network and a public data (IP) network, or to the number of networks chosen. Thus a plurality of private networks, a plurality of public data networks and a plurality of public telephone networks (for example of the PSTN, PLMN (and in particular GSM, GPRS, UMTS, or i-Mode) type) could coexist.

Moreover, the terminals T1, T2 of the private network EN are considered to be registered with a manager device GK1 that is responsible, in the conventional way, for negotiating and setting up their transmission channels when they wish to transmit data to other terminals, whether internal to said private network EN (terminals T2, T1) or external thereto (terminal T3). In other words, the manager device GK1 knows the characteristics of the terminals T1 and T2 and in particular their data transmission (sending and receiving) capacities. The manager device GK1 is preferably a gatekeeper, for example installed in the IP router S1, as shown here.

The terminals external to the private network EN (in this example represented by the terminal T3) are further considered to be registered with another manager device GK2 that is responsible, in the conventional way, for negotiating and setting up their transmission channel when they wish to transmit data to other terminals belonging, where applicable, to the private network EN. In other words, the manager device GK2 knows the characteristics of the terminals T3 and in particular their data transmission (sending and receiving) capacities. The manager device GK2 is preferably a gatekeeper, for example installed in the access server S2, as shown here.

Of course, the manager devices could be installed in network equipment other than the IP router S1 or the access server S2. For example, they could be installed in messaging or electronic mail servers, in dedicated machines connected to the terminals or in dedicated units that can be connected to servers.

According to the invention, the installation further includes at least one data processor device D comprising a manager module MG connected to the communication network, which here is an Internet/IP network, and responsible for determining, each time it receives a request for transmission of data between a sending terminal and a receiving terminal, information data representative of at least one of the transmission (send/receive) characteristics of the network connection CMi of the receiver terminal and/or at least one of the transmission (send/receive) characteristics of the network connection CMi of the sender terminal.

As shown in the single FIGURE, a processor device D of the invention is preferably associated with each manager device GK. The processor device D can even be installed in the manager device GK.

When a first sender, for example T1, requires to transmit data to a receiver terminal, for example T3, it transmits a transmission channel set-up request to the first gatekeeper GK1. The latter communicates the request to the manager module MG, which starts by determining the gatekeeper with which the receiver terminal T2 is registered. In the example shown, this is the second gatekeeper GK2 installed on the access server S2.

The manager module MG then instructs the first gatekeeper GK1 to set up a connection to the second gatekeeper GK2 in order to determine at least one of the transmission characteristics of the network connection CM3 used by the receiver terminal T3. It is preferably the bandwidth of the network connection CM3 that is determined.

The first gatekeeper GK1 then sets up a standard connection to the second gatekeeper GK2, as it would do in the absence of the processor device D. This connection is not described here because it is well known to the person skilled in the art and depends on the type of data to be exchanged between the sender and receiver terminals. Suffice to say that the connection is effected on a logical signaling channel, also known as a control plan or “plan C2”, and is usually for exchanging information data representative of the characteristics, in particular the transmission characteristics, of the sender and receiver terminals. For example, in the case of a Multimedia over IP (MoIP) data exchange, the connection conforms to the ITU's H.245 standard.

The first gatekeeper GK1 then requests the second gatekeeper GK2 to determine the bandwidth of the network connection CM3 of the terminal T3 that is registered with it, and at the same time can supply it with the characteristics of the sender terminal T1. Two situations may then be envisaged.

In the first situation, the second gatekeeper GK2 already has in its memory the information data representative of the bandwidth of the network connection CM3, because the terminal T3 has previously communicated this data to it, for example because it was aware that it was going to have to receive data via its network connection CM3.

In the second situation, the second gatekeeper GK2 does not know the information data representative of the bandwidth of the network connection CM3 of the terminal T3. Consequently, the second gatekeeper GK2 interrogates the receiver terminal T3, preferably on their dedicated signaling channel, to ask it to communicate the data to it. The receiver terminal T3 communicates its information data to it via the RTP network, and does this immediately, as it has known this information data since it was initialized. On receiving this information data, the second gatekeeper GK2 transmits it to the first gatekeeper GK1 with the information data representative of the characteristics of the receiver terminal T3, which it has in its memory (because the latter terminal is registered with it).

Once the first gatekeeper GK1 is in possession of the bandwidth of the network connection CM3 and the characteristics of the receiver terminal T3 and the sender terminal T1, it remains only for it to determine the bandwidth of the network connection CM1 of the sender terminal T1. Two situations can be envisaged.

In the first situation, the first gatekeeper GK1 already has this information in its memory, either because the terminal T1 is a fixed terminal and it has recently set up transmission channels for it, or because the sender terminal T1 has communicated its data transmission request to it accompanied by information data representative of the bandwidth of its network connection CM1.

In the second situation, the first gatekeeper GK1 does not know the information data representative of the bandwidth of the network connection CM1 of the terminal T1. Consequently, the manager module MG instructs the first gatekeeper GK1 to obtain that information data from the sender terminal T1. The first gatekeeper GK1 then requests the sender terminal T1, preferably on their dedicated signaling channel, to communicate the data to it. The sender terminal T1 communicates its information data to it immediately, as it has known this data since it was initialized.

In either form, once the first gatekeeper GK1 is in possession of the bandwidth of CM1, the procedure for obtaining the information data terminates. The first gatekeeper GK1 and the second gatekeeper GK2 can then negotiate, at the plan C level, the characteristics of the transmission channel best suited to the characteristics of the terminals T1 and T3 given, firstly, the type of data to be transmitted and, secondly, the bandwidths of the network connections CM1 and CM3. Then, once the negotiation has been terminated, they request the network to set up the transmission channel negotiated as part of the user plan (or “plan U” as it is otherwise known). Because the terminals T1 and T3 are then connected to each other, they can exchange information data to configure themselves as best they can, each on its own side, given the data they are going to have to exchange. Transmission of data between the terminals T1 and T3 can then begin.

Of course, if the negotiation at the plan C level does not lead to the definition of a suitable transmission channel, the sender terminal is advised of this and the request is rejected.

The same type of procedure is executed when the sender is a terminal external to the private network EN, for example the terminal T3. However, in this case, the processor device D installed in the access server S2 manages the procedure for obtaining information data on the network connections.

On the other hand, a significantly different procedure must be used if the sender terminal belongs to the private network EN but is connected to it via another network, such as the Internet/IP network. This is the case of the mobile terminal T4 in particular (shown here as a portable computer) which, in the example shown in the single FIGURE, is connected to the Internet/IP network via its network connection CM4.

In this case, T4 is registered with the first gatekeeper GK1, which therefore knows the characteristics of the terminal itself, and not those of its network connection CM4, which is no longer the same as the one it usually employs when it is connected directly to the private network EN.

Because the terminal T4 is registered with the first gatekeeper GK1, it sends the latter its request for setting up a transmission channel via the RTP network, the access server S2 and the Internet/IP network. On receiving this request, the first gatekeeper GK1 communicates it to the manager module MG, which first determines the gatekeeper with which the receiver terminal, for example the terminal T2, is registered. In the example shown, this is also the first gatekeeper GK1.

The manager module MG installed in the server S1 (which here is an IP router) then instructs the first gatekeeper GK1 to determine at least one of the transmission characteristics of the network connection CM4 used by the sender terminal T4, preferably the bandwidth of the network connection CM4.

The first gatekeeper GK1 then uses the logical signaling channel usually dedicated to exchanging signaling with the terminal T4 to request it to communicate the bandwidth of its network connection CM4. The sender terminal T4 communicates its information data immediately because it has known the information data since it was initialized.

Of course, it can be envisaged that the sender terminal T4 provides the data representative of the bandwidth of its network link CM4 at substantially the same time as submitting its connection set-up request. In this case, the step of determining information data between the first gatekeeper GK1 and the sender terminal T4 does not take place (it is effected in the memory of the first gatekeeper GK1).

Because the first gatekeeper GK1 is then in possession of the bandwidth of the network connection CM4 and of the characteristics of the receiver terminal T2 and the sender terminal T4 (it has them in its memory since they are both registered with it), it remains only for it to determine, where applicable, the bandwidth of the network connection CM2 of the receiver terminal T2. Two situations can again be envisaged.

In a first situation, the first gatekeeper GK1 already has this information in its memory, because the terminal T2 is a fixed station and it has recently set up transmission channels for it.

In the second situation, the first gatekeeper GK1 does not know the information data representative of the bandwidth of the network connection CM2 of the receiver terminal T2. Consequently, the manager module MG instructs the first gatekeeper GK1 to obtain this information data from the receiver terminal T2. The first gatekeeper GK1 then requests the receiver terminal T2, preferably on their dedicated signaling channel, to communicate that data. The receiver terminal T2 communicates its information data immediately since it has known the information data since it was initialized.

In either case, once the first gatekeeper GK1 is in possession of the bandwidth of the network connection CM2, the procedure for obtaining information data terminates. Being the only gatekeeper involved, the first gatekeeper GK1 determines (at the plan C level) the characteristics of the transmission channel best suited to the characteristics of the terminals T4 and T1 given, firstly, the type of data to be transmitted and, secondly, the bandwidths of the network connections CM4 and CM2. Then, once those characteristics have been determined, it requests the network to set up the transmission channel negotiated at the level of the user plan (or “plan U”). Because the terminals T4 and T2 are then connected to each other, they can exchange information data to configure themselves as well as possible, each on its own side, given the data that they wish to exchange. The transmission of data between T4 and T2 can then commence.

Of course, if the negotiation at the plan C level fails to define a suitable transmission channel, the sender terminal is advised of this and its request is rejected.

Each processor device D can take the form of electronic circuits (hardware), electronic data processing modules (software), or a combination of hardware and software. Consequently, the processor device D can take the form of a unit adapted to be connected to a network gatekeeper, for example, or constitute a network gatekeeper, for example, if it integrates the function of negotiating and setting up transmission channels, and not only the function of extracting network connection characteristics.

The invention also provides a data processing method for setting up data transmission channels between sender terminals and receiver terminals suited to the network connections by which they are connected to a communication network.

The method can be implemented with the aid of the processor device D described above. The main and optional functions and subfunctions provided by the steps of this method being substantially identical to those provided by the means constituting the processor device D, only the steps implementing the main functions of the method according to the invention are summarized hereinafter.

This method consists in determining, each time that the setting up of a data transmission channel between a sender terminal and a receiver terminal is requested, information data representative of at least one of the send/receive characteristics of the network connection of the receiver terminal and/or information data representative of at least one of the send/receive characteristics of the network connection of the sender terminal, in order to negotiate and set up a data transmission channel between the sender and receiver terminals suited to their respective capacities and to the characteristics of their respective network connections, given the type of data to be transmitted.

The invention is not limited to the embodiments of the method, the manager device GK and the processor device D described above by way of example only, but encompasses all variants that the person skilled in the art might envisage within the scope of the following claims.

Thus, the foregoing description refers to a communication installation including a private network belonging to a business or to a group of businesses and connected to an Internet/IP public network itself connected to a public telephone network. However, the invention also relates to installations that include only one public or private network or a plurality of public and/or private networks.

Moreover, an application has been described in which the sender and receiver terminals are fixed or portable computers. However, the invention relates generally to all fixed or portable machines capable of exchanging data (multimedia, channel, image or text data) with a communication network (of any type), including mobile telephones and personal digital assistants (PDA).

Furthermore, an installation has been described in which each gatekeeper is associated, by way of its manager module, with a data processor device according to the invention, within a server or router. However, the processor device of the invention can be installed in the manager device of the gatekeeper or in other network equipments, for example messenger or electronic mail servers, or in dedicated machines connected to the terminals, or again in dedicated units connectable to servers.

1. A method of processing data, for setting up data transmission channels between sender terminals and receiver terminals connected to a communication network by first and second connection means, which method is characterized in that it consists, in the event of a request to set up a data transmission channel between a sender terminal (T1; T4) and a receiver terminal (T3; T2), in determining information data representative of at least one of the send/receive characteristics of the second connection means (CM3; CM2) of said receiver terminal (T3; T2) and/or information data representative of at least one of the send/receive characteristics of the first connection means (CM1; CM4) of said sender terminal (T1; T4), in order to negotiate and set up a data transmission channel between said sender and receiver terminals suited to their respective capacities and to the characteristics of their first and second connection means.

2. A method according to claim 1, characterized in that some of said information data is representative of the bandwidth of the second connection means (CM3; CM2).

3. A method according to claim 1, characterized in that at least some of said information data is representative of the bandwidth of the first connection means (CM1; CM4).

4. A method according to claim 1, characterized in that information data representative of send/receive characteristics of the first connection means (CM1; CM4) is communicated substantially with said data transmission channel set-up request before determining said information data of the second connection means (CM3; CM2).

5. A method according to claim 1, characterized in that information data representative of send/receive characteristics of the first connection means (CM1; CM4) is determined after determining information data of the second connection means (CM3; CM2).

6. A method according to claim 1, characterized in that said transmission channel between said sender terminals (T1; T4) and receiver terminals (T3; T2) is negotiated and set up after said determination of information data.

7. A data processor device (D) for setting up data transmission channels between sender terminals (T1; T4) and receiver terminals (T3; T2) connected to a communication network by first connection means (CM1; CM4) and second connection means (CM3; CM2), which device is characterized in that it comprises manager means (MG) connected to said communication network and adapted to receive a request for transmission of data between a sender terminal (T1; T4) and a receiver terminal (T3; T2), to determine information data representative of at least one of the send/receive characteristics of the second connection means (CM3; CM2) of said receiver terminal (T3; T2) and/or information data representative of at least one of the send/receive characteristics of the first connection means (CM1; CM4) of said sender terminal (T1; T4), for negotiating and setting up a data transmission channel between said sender and receiver terminals suited to their respective capacities and to the characteristics of their first and second connection means.

8. A device according to claim 7, characterized in that said manager means (MG) are adapted to determine information data representative of the bandwidth of the second connection means (CM3; CM2).

9. A device according to claim 7, characterized in that at least some of said information data is representative of the bandwidth of the first connection means (CM1; CM4).

10. A device according to claim 7, characterized in that said manager means (MG) are adapted to receive information data representative of send/receive characteristics of the first connection means (CM1; CM4) of said sender terminal (T1; T4) at substantially the same time as said data transmission channel set-up request.

11. A device according to claim 7, characterized in that said manager means (MG) are adapted to determine information data for said first connection means (CM1; CM4) of said sender terminal (T1; T4) after determination of said information data for said second connection means (CM3; CM2).

12. A device according to claim 7, characterized in that said manager means (MG) are adapted to communicate said information data to at least one manager device (GK) with which at least said sender terminal (T1; T4) is registered and which is responsible for negotiating and setting up said data transmission channel between said sender terminal (T1; T4) and receiver terminal (T3; T2) within said network.

13. A device according to claim 7, characterized in that said manager means (MG) are adapted to determine said information data via at least one logical signaling channel.

14. A communication network manager device (GK), characterized in that it comprises a data processor device (MG) according to any one of claims 7 to 13.

15. A manager device (GK) according to claim 14, characterized in that it takes the form of a server chosen in a group comprising at least messaging servers, electronic mail servers, firewall servers and proxy servers.
